(19) United States
(12) Patent Application Publication
(10) Pub. No.: US 2015/0254712 A1
(43) Pub. Date: Sep. 10, 2015

(54) SYSTEMS AND METHODS FOR DEVICE PROMOTIONS BASED ON USER ACCOUNT COMMUNITY ACTIVITY

(71) Applicant: EBAY INC., San Jose, CA (US)

(72) Inventor: Hui-Min Chen, San Jose, CA (US)

(21) Appl. No.: 14/203,155

(22) Filed: Mar. 10, 2014

(51) Int. Cl. G06Q 30/02

(52) U.S. Cl. CPC G06Q 30/0255

(57) ABSTRACT

There is provided systems and method for device promotions based on user account community activity. Users possess user accounts for devices, including mobile device, which may be collected into account communities based on shared account characteristics. When one account purchases a product using a payment provider, transaction data may be transmitted to an administrator of the account community. Additionally, sellers of the product offering the same and/or similar products may subscribe to a service for advertising to the account communities. The sellers may transmit promotional material to the administrator. Using characteristics of the transaction data, the seller, and/or the promotion, a predictive score may be calculated based on the likelihood one of the users will accept the promotion. The promotions may be retrieved by the users using an application with their user account, or may be pushed to the user device for the user account.

### TECHNICAL FIELD

The present application generally relates to device promotions based on user account community activity and more specifically to targeted promotions to user devices including mobile devices based on the same or similar purchases from users in a user account community.

### BACKGROUND

Users may utilize user accounts to purchase online goods or engage in other online transactions. When making purchases, users normally either know of a need or view an advertisement in order to make a decision to purchase. Where advertisements are generally broadcast to users (e.g., through video/audio/print advertisements widely available to the public), the advertisement strategy is inefficient and some users may entirely avoid such advertisements. Thus, marketers of goods and services may waste resources and fail to reach certain members of a targeted audience for the advertisements.

Targeted advertisements may help conserve resources and/or appeal more specifically to certain groups. Targeted advertisements may also benefit marketers and/or merchants where the medium of transmission may limit an amount of transmitted advertisements or the user may easily avoid advertisements (e.g., spam filters in email accounts). In order to target products to certain audiences, the marketer must know the audiences interests. Some marketers may do this through audience surveys or data mining actions by the audience, such as visited websites, stores, etc. However, such information remains only relevant to an individual purchaser in the audience. Thus, the marketer may miss opportunities to advertise to similar individuals that would likely be interested in the same or similar products.

### BRIEF DESCRIPTION OF THE DRAWINGS

FIG. 1 is a block diagram of a networked system suitable for implementing the process described herein, according to an embodiment;

FIG. 2A is an exemplary database for an advertising server having data used to promote to user accounts in an account community, according to an embodiment;

FIG. 2B is an exemplary server executing a device advertisement application to promote to user accounts in an account community, according to an embodiment;

FIG. 3 is a flowchart of an exemplary process by a server for mobile device promotions based on user account community activity, according to an embodiment; and

FIG. 4 is a block diagram of a computer system suitable for implementing one or more components in FIG. 1, according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

A server may offer account community services to a plurality of user accounts. A user account may correspond to an email, payment, merchant, social networking, etc., account established by a user. Account community services may offer account linking that establishes a community of one or more user accounts. The server may determine one or more account communities based on one or more user accounts sharing a feature, information, identifier, or other characteristic. For example, the accounts may belong to the same user or the same user may utilize share identifiers, financial information (e.g., credit/debit card numbers and usage), shipping addresses, etc. In other embodiments, the accounts may belong to a plurality of users sharing the account characteristic, such as general area (e.g. zip code or city). Additionally, the owner(s) of the user account(s) may also link the user account(s) through information and/or input provided to the server (e.g., providing names, identifiers, etc. of each account owned by a user or accounts associated with a plurality of linked users, such as a family, group of friends, etc.).

Once one or more account communities are established by the server, the server may receive information about purchases by users in the community. For example, a user may utilize one or more of the user accounts to complete a purchase with a merchant. The purchase may create transaction information corresponding to a product (e.g., items, goods, and/or service), the merchant, and the buyer. The merchant (or any other seller) may subscribe to a community based advertisement program of the server that utilizes the account communities to advertise to the user accounts in the communities. Thus, the merchant may submit transaction information for the purchase with a product identification number or product identifier (PID) to the server. The server may utilize the PID to associate the transaction information with future advertising campaigns.

The merchant, seller, or a marketer/advertiser for the merchant/seller, may submit promotions corresponding to the PID to the server. Once promotions for a PID are received, the server may access one or more account communities and determine a match score between the community and every account in the community. The match score determines whether the community and/or an account in the community may accept the promotion and purchase the product corresponding to the PID from the promotion. The match score may be based on the promotion, the transaction information, the product, or other information. The server may access the same community as the purchasing account is in and cross-sell within the community. However, based on similar or shared transaction information, the server may access a second community and cross-sell across communities. The similar or shared transaction information may include the same or similar purchased products, sellers, etc.

Match scores may be determined, normalized, and aligned so that each user account's score determines a likelihood of accepting a promotion and matching scores determine an equal likelihood of acceptance. Once match scores have been determined, the server may apply filters or eligibility criteria to accounts with sufficiently high match scores. For example, a filter may limit user accounts to a geographic area, demographic, etc. based on interests of the merchant/seller and/or the buyer accounts. Results that pass the filters may be retained for advertisements.

A user account retained for advertisements may be required to log in to the server or the community advertisement service in order to receive the promotions. However, in certain embodiments, the community advertisement service may transmit promotions to the retained user accounts. Once promotions are accessed by the user account, post-advertisement analysis may be conducted to determine the promotions success and/or the user account's response to the promotion. The merchant, seller, and/or marketer may view the promotions results for future advertisement campaigns.

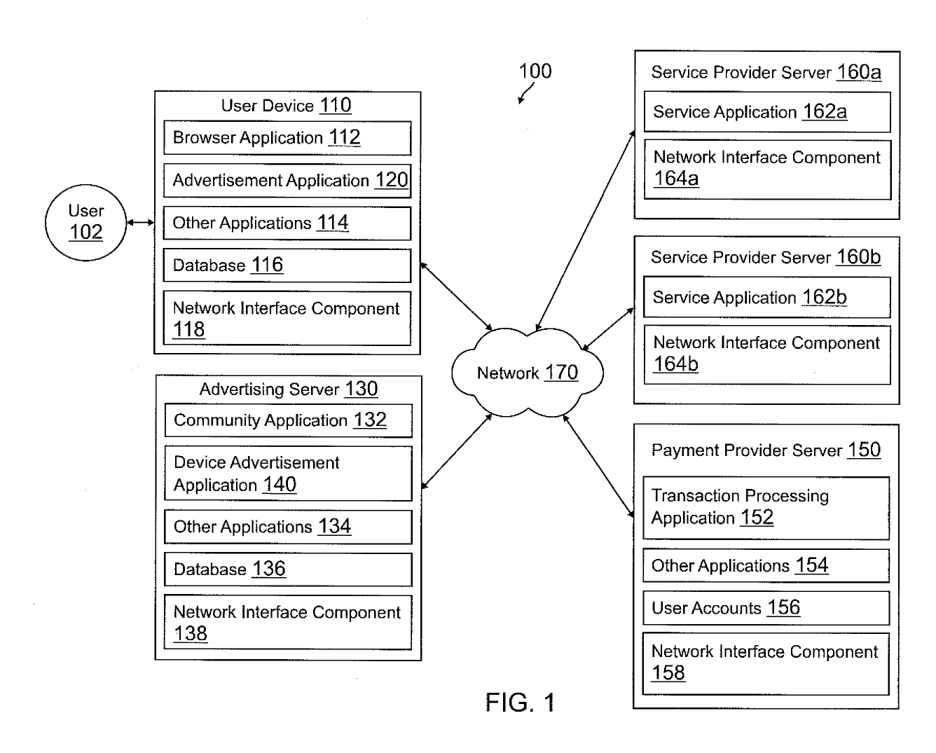

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, an advertising server 130, a payment provider server 150, a service provider server 160a, and a service provider server 160b in communication over a network 170. User 102, such as a consumer, utilizes user device 110 to establish user accounts with various service and payment providers. These actions may be facilitated by advertising server 130, payment provider server 150, service provider server 160a, and service provider server 160b in certain embodiments. Once one or more user accounts is established, user 102 may engage in transactions for one or more products with service provider server 160a and/or service provider server 160b. Such transactions may be completed using payment provider server 150. The transactions, transaction information, and product identification number or product identifier (PID) may be transmitted to advertising server 130, which may also receive promotions from service provider server 160a and/or service provider server 160b. Advertising server 130 may access account communities and advertise the promotions to accounts in the account communities using the transactions, transaction information, PID, and/or other information.

User device 110, advertising server 130, payment provider server 150, service provider server 160a, and service provider server 160b may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

User device 110 may be implemented using any appropriate hardware and software configured for wired and/or wireless communication over network 170. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a browser application 112, an advertisement application 120, other applications 114, database 116, and a network interface component 118. Browser application 112, advertisement application 120, and other applications 114 may correspond to processes, procedures, and/or applications executable by a hardware processor, for example, a software program. In other embodiments, user device 110 may include additional or different software as required.

Browser application 112 may be used, for example, to provide a convenient interface to permit a user to browse information available over network 170 and establish, maintain, and utilize user accounts available on service providers, including payment provider server 150, service provider server 160a, and/or service provider server 160b. In certain embodiments, browser application 112 may be implemented as a web browser configured to view information available over the Internet or access a website of a service provider, including payment provider server 150, service provider server 160a, and/or service provider server 160b. For example, browser application 112 may be utilized to access marketplace websites and engage in online transactions with a service application of service provider server 160a and/or service provider server 160b. Additionally, browser application 112 may access other service provider websites, such as payment provider server 150, to facilitate online payments, financial websites to view financial information and engage in financial transactions, messaging websites, social networking websites, and/or other online source.

Browser application 112 may further be utilized to establish, access, and maintain user accounts and engage in online transactions using the user accounts established with payment provider server 150, service provider server 160a, and/or service provider server 160b. For example, browser application 112 may be utilized to establish one or more user accounts with a merchant, a payment provider, a financial institution, an email account provider, a social networking provider, or other service provider. Browser application 112 may access the service provider to utilize the user accounts. The user accounts may interact with other service providers, for example, by facilitating online transactions, transmitting and receiving email messages, etc. User 102 may utilize browser application 112 to transmit and store information with the user accounts, such as personal information (e.g., name, address, etc.), banking/financial information, and other information. Additionally, the provider of the user account may receive other user information corresponding to the user accounts, such as an IP address, machine cookie, or other user account related information when user 102 establishes or utilizes the user account.

User device 110 include advertisement application 120 configured to provide an interface allowing user 102 to request and/or receive promotions from advertising server 130. In this regard, advertisement application 120 may correspond to an application having processes and/or procedures enabling user 102 to view promotions and/or other advertisements targeted to user 102 available from advertising server 130. Advertisement application 120 may access advertising server 120 on user 102's command to receive the promotions (e.g., a pull advertisement strategy) or advertising server 130 may transmit promotions to user device 110 for viewing with advertisement application 120 (e.g., a push advertisement strategy). Advertisement application 120 may correspond to an application specific to advertising server 130, such as an application offered for download from advertising server 130 or a corresponding server (e.g., an application store server). In other embodiments, advertisement application 120 may correspond to another application for receiving advertisements, including a text messaging (e.g., SMS/MMS messaging), social networking, microblogging, image/video, etc., application. In various embodiments, the described processes of advertisement application 120 may be offered by browser application 112 through accessing a website or other service of advertising server 130. Additionally, browser application 112 may also display promotions received through advertisement application 120, such as embedded hyperlinks, website addresses, etc. Advertisement application 120 may further track user 102's responses to promotions (e.g., views, accepts, and/or purchases of products from an advertisement) and transmit the response data to advertising server 130 for use in determining promotion/advertisement strategies.

In various embodiments, browser application 112 and advertisement application 120 may be incorporated in the same application so as to provide their respective features in one convenient application interface.

In various embodiments, user device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications associated with payment provider server 150. Other applications 114 may contain software programs, executable by a processor, including a graphical user interface (GUI) configured to provide an interface to the user.

User device 110 may further include database 116 which may include, for example, identifiers such as operating system registry entries, cookies associated with browser application 112, advertisement application 120, and/or other applications 114, identifiers associated with hardware of user device 110, or other appropriate identifiers, such as identifiers used for payment/user/device authentication or identification. In certain embodiments, identifiers in database 116 may be used by an account provider, such as payment provider server 150, service provider server 160a, and/or service provider server 160b, to associate user device 110 with a particular account maintained by the account provider. Database 116 may include access information for one or more user accounts, user information (i.e., personal, financial, etc. information), and/or user transaction information for use by advertising server 130, payment provider server 150, service provider server 160a, and/or service provider server 160b. Furthermore, database 116 may further include promotions received from advertising server 130 and/or user 102's responses to the promotions.

In various embodiments, user device 110 includes at least one network interface component 118 adapted to communicate with advertising server 130, payment provider server 150, service provider server 160a, and/or service provider server 160b over network 170. In various embodiments, network interface component 118 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Advertising server 130 may be maintained, for example, by an advertising/marketing entity, which may provide advertisement opportunities to vendors by providing targeted promotions to user 102 through match scores based on account communities and user 102's account(s) in the account communities. In this regard, advertising server 130 may including one or more advertisement/marketing applications configured to collect transaction information and promotions for a PID and transmit the promotions to one or more accounts in an account community. While advertising server 130 is shown as separate from payment provider server 150, service provider server 160a, and service provider server 160b, it is understood the services provided by advertising server 130 may be incorporated within one or more of payment provider server 150, service provider server 160a, and service provider server 160b.

Advertising server 130 includes a community application 132, a device advertisement application 140, other applications 134, a database 136, and a network interface component 138. Community application 132, device advertisement application 140, and other applications 134 may correspond to processes, procedures, and/or applications executable by a hardware processor, for example, a software program. In other embodiments, advertising server 130 may include additional or different software as required

Advertising server 130 includes community application 132, which may be configured to offer account community services to one or more users, including user 102. In this regard, community application 132 may create a community of user accounts. More than one user account may be associated in an account community based on shared account characteristics. For example, the account characteristics may correspond to user specific and/or device specific information. The account characteristic may correspond to credit card information, debit card information, physical location (e.g. a home address, city, and/or country), and/or bank account information, which may be entered by a user when setting up and/or managing a user account with payment provider server 150, service provider server 160a, and/or service provider server 160b. Additionally, the account characteristic may correspond to other information obtained from user device 110 when user 102 establishes, maintains, or utilizes a user account, such as an IP address of a device used to access the user account and/or a machine cookie. The account characteristic may also correspond to online transactions engaged in by the user account, for example, purchases of products from one or more user accounts established on service provider server 160a and/or service provider server 160b with one or more user accounts on payment provider server 150.

The other user accounts in an account community may belong to the same user, for example, accounts sharing the same personal information, financial information or other user specific characteristic. However, in other embodiments, the user accounts in an account community may belong to a plurality of users sharing the characteristic, such as a physical address, IP address (where a plurality of users may access a plurality of accounts belonging to each user using one IP address), account actions, or other non-user specific characteristic. For example, an account community may include user accounts for a single user, a family, a group of friends, coworkers, etc.

Once an account community is established by community application 132, advertising server 130 may maintain and advertise to the community. Advertising server 130 and/or an administrator of advertising server 130 may enable a seller, merchant, advertiser/marketer, or other entity (e.g., payment provider server 150, service provider server 160a, and/or service provider server 160b) to subscribe to and/or utilize a community-based advertising program. The program may be utilized generally with all user devices, including user device 110, or may be specific to mobile user devices (e.g., feature/smart phones, tablets, etc.), which may limit advertisement size, number, and/or method of communication. Once an account community is established and an entity submits promotions and other information for the community-based advertising program, device advertisement application 140 may process the information for use with account communities of community application 132.

Advertising server 130 includes device advertisement application 140, which may provide advertising/marketing opportunities to entities (e.g., a seller, merchant, advertiser/marketer, or other vendor) based on the account communities and the user accounts in the account communities. Payment provider server 150, service provider server 160a, and/or service provider server 160b or other vendor, may desire to transmit advertisements, coupons, sale offers, or other promotions to user accounts of an account community. Thus, device advertisement application 140 may therefore determine a likelihood of a user account in an account community accepting targeted promotions based on received information from user device 110, payment provider server 150, service provider server 160a, and/or service provider server 160b.

A buyer, such as user 102 or another user, may purchase products and generate transaction information. A seller, merchant, or other entity that completes the transaction (e.g., payment provider server 150, service provider server 160a, and/or service provider server 160b) may submit the transaction, transaction information, and a Product Identifier (PID) corresponding to the purchased product to advertising server 130. Once the transaction information is received for the PID, the transaction information may be stored by device advertisement application 140 to database 134. The transaction information may include a seller identification, a buyer identification, a transaction identification, a buyer account community identification, and/or a timestamp of the transaction.

The seller, merchant, advertiser/marketer, or other entity may submit promotions to device advertisement application 140. The promotions may correspond to the PID and be stored by device advertisement application 140 to database 136. A promotion may correspond to an advertisement, coupon, rebate, or other marketing strategy for a user, such as user 102 or other user in an account community. Device advertisement application 140 may store the promotion with a promotion identification, a promotion detail, the PID, a seller identification, promotional status, eligibility criteria, and/or a timestamp of the promotion. Each promotion may thus have eligibility criteria, such as duration, location, availability, constraints, preferred targeted customers, etc.

In order to determine a user account to transmit a promotion to, device advertisement application 140 may utilize a predictive engine that generates a match score corresponding to a likelihood that the receiving user (or user account) accepts the promotion (views the promotion, purchases the product in the promotion, etc.). The match score for each user account may be generated based on a score of an account community and a score of the user account in the account community. Thus, the match score may comprise two individual scores, the account community's score and the user account's score. The two scores may be combined to determine the match score, with each score receiving a relative weight in the match score. The weight applied to each score may be decided by advertising server 130, an administrator of advertising server 130, the merchant/seller/advertiser generating the promotions for user account, or may depend on each individual score.

Each individual score making up the match score is normalized and aligned so that two scores of the same value suggest that they are equally likely to accept the promotion. Thus, each score may comprise a value, for example, from 0 to 1. The score determined for the account community may be based on promotion information and account community information and correspond to a likelihood user accounts in the account community will accept the promotion. The score determined for the user accounts in the account community may be based on the promotion information and the individual user accounts and correspond to a likelihood the individual user accounts accept the promotion. The scores may be determined using based on at least one of an account profile of the user accounts, a purchase history of the user accounts, a response to a similar promotion by the user accounts, a financial account of the user accounts, a location corresponding to the user accounts, preferences of the user accounts, a user device of the user accounts, performance characteristics of a user device corresponding to a user account, and usage characteristics of the user device.

Seller information may also be a factor in determining the match score by device advertisement application 140. For example, a seller category, a seller URL, seller availability, a seller location, and/or a seller liability coverage and delivery for the product may be used to determine a likelihood a user account accepts a promotion. The seller information may be compared to a user history having previously seller interaction information to determine the match score.

In various embodiments, device advertisement application 140 may determine match scores of a promotion for user accounts in an account community based on a purchase of a product corresponding to the promotion's PID by a user account in the account community. For example, a user account in an account community may purchase a product corresponding to a PID. Thus, when promotions for that PID are submitted to device advertisement application 140, device advertisement application 140 determines match scores for other user accounts in that account community. This would correspond to cross-promotion/selling within an account community.

Additionally, device advertisement application 140 may cross-promote/sell to user accounts in different communities. For example, device advertisement application 140 may determine match scores for user accounts in a separate account community to a user account that purchases a product corresponding to the promotion's PID. In such embodiments, at least one user account in the separate community may purchase from the same or similar seller/merchant as the user account that purchased the product. Thus, based on a common seller across two account communities, promotions may be advertised to separate account communities.

Once a match score is determined for each user account in an account community, a promotion may be advertised to user accounts with match scores exceeding a threshold. Thus, if a match score threshold is set at a 0.7 on a 0 to 1 scale, match scores at or exceeding this value may receive a promotion for that match score. In various embodiments, filters may be applied to match scores prior to receiving the promotion, such as seller/merchant/advertiser target locations, demographics, user histories, etc. For example, a seller may wish to only advertise to 18-29 year olds, users in metropolitan areas, etc.

If a match score exceeds the threshold and any filters or eligibility criteria, the promotion may be designated for the user account corresponding to that match score. Two advertising models may be utilized to advertise the promotion to the user through the user account. In a pull strategy, the user, including user 102 or other user, may log in to an advertising service through an application of a user device, such advertisement application 120 of user device 110, in order to view and/or receive the advertisement. Alternatively, in a push strategy, the promotion may be transmitted to the application of the user device, such advertisement application 120 of user device 110, for viewing. Once the promotion is received by the user, user actions, such as viewing, deleting, utilizing, and/or purchasing a product corresponding to the promotion, may be recorded and transmitted to advertising server 130 for use in future promotions and/or advertising strategies.

In various embodiments, advertising server 130 includes other applications 134 as may be desired in particular embodiments to provide features for advertising server 130. For example, other applications 134 may include security applications for implementing server-side security features, programmatic server applications for interfacing with appropriate application programming interfaces (APIs) over network 170, or other types of applications. Other applications 134 may contain software programs, such as a graphical user interface (GUI), executable by a processor that is configured to provide an interface to the user.

Advertising server 130 includes database 136, which may be configured to store user account identifiers, account community information, and/or promotion material. Database 136 may further include transaction information, seller information, promotion information, and/or match score information for user accounts, as previously discussed. Database 136 may include information about user actions in response to the promotions for use in future promotions and/or advertising strategies.

In various embodiments, advertising server 130 includes at least one network interface component 138 adapted to communicate with network 170 including user device 110, payment provider server 150, service provider server 160a, and/or service provider server 160b. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Payment provider server 150 may be maintained, for example, by an online payment service provider, which may provide payment services and/or processing for financial transactions on behalf of a user with a merchant. In this regard, payment provider server 150 includes one or more processing applications which may be configured to interact with user device 110, advertising server 130, service provider server 160a, and/or service provider server 160b provide targeted promotions and facilitate payment for a transaction. In one example, payment provider server 150 may be provided by PAYPAL®, Inc. of San Jose, Calif., USA. However, in other embodiments, payment provider server 150 may be maintained by or include a credit provider, financial services provider, financial data provider, and/or other service provider, which may provide payment services to user 102. Although payment provider server 150 is shown as separate from advertising server 130, in various embodiments payment provider server 150 and advertising server 130 may be incorporated together or include the same or similar functions.

Payment provider server 150 of FIG. 1 includes a transaction processing application 152, other application 154, user accounts 156, and a network interface component 158. Transaction processing application 152 may correspond to processes, procedures, and/or applications executable by a hardware processor, for example, a software program. In other embodiments, payment provider server 150 may include additional or different software as required.

Transaction processing application 152 may be configured to receive and/or transmit information from user device 110, service provider server 160a, and/or service provider server 160b for processing and completion of financial transactions. Transaction processing application 152 may include one or more applications to process financial transaction information from user device 110, service provider server 160a, and/or service provider server 160b by receiving a request to complete a sale transaction for items/services/goods. The request may correspond to a payment from user device 110 to service provider server 160a and/or service provider server 160b. The payment may include a user account identifier (e.g., a payment account for user 102 with payment provider server 150) or other payment information (e.g. a credit/debit card or checking account). Additionally, the payment may include a payment amount and terms of payment. Transaction processing application 152 may complete the sale transaction by providing payment to service provider server 160a and/or service provider server 160b. Additionally, transaction processing application 152 may provide transaction histories, including receipts, to user device 110, advertising server 130, service provider server 160a, and/or service provider server 160b for completion and documentation of the financial transaction. Transaction histories provided to advertising server 130 may be utilized for promotions to user accounts in account communities.

Payment provider server 150 includes other applications 154 as may be desired in particular embodiments to provide features to payment provider server 150. For example, other applications 154 may include security applications for implementing server-side security features, programmatic server applications for interfacing with appropriate application programming interfaces (APIs) over network 170, or other types of applications. Other applications 154 may contain software programs, such as a graphical user interface (GUI), executable by a processor that is configured to provide an interface to a user.

Additionally, payment provider server 150 includes user accounts 156. As previously discussed, user 102 may establish one or more user accounts with payment provider server 150. User accounts 156 may include user information, such as name, address, birthdate, payment/funding information, additional user financial information, and/or other desired user data. User 102 may link user accounts 156 to user device 110 through a user device identifier. Thus, when a device identifier corresponding to user device 110 is transmitted to payment provider server 150, e.g. from user device 110, advertising server 130, service provider server 160a, and/or service provider server 160b, a user account belonging to user 102 may be found. More generally, user accounts 156 may correspond to an account established by a user and maintained for engaging in online transactions. User accounts 156 may actively request information, allow a user to submit information, or may retrieve information corresponding to user 102 and/or user device 110, such as by monitoring IP addresses used to access the user account, locations of access, machine cookies, or other user and/or device specific data. However, in other embodiments, user 102 may not have previously established a user account. Thus, payment provider server 150 may complete a transaction based on another user financial account received from user device 110, advertising server 130, service provider server 160a, and/or service provider server 160b.

In various embodiments, payment provider server 150 includes at least one network interface component 158 adapted to communicate with user device 110, advertising server 130, service provider server 160a, and/or service provider server 160b over network 170. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Service provider server 160a and service provider server 160h may be maintained, for example, by a service provider offering a service for user 102. Service provider server 160a and service provider server 160b may correspond generally to a merchant or seller offering various items, products, and/or services through an online site or application and be maintained by anyone or any entity that receives money, which includes charities as well as retailers and restaurants. In this regard, service provider server 160a and service provider server 160b may include processing applications, which may be configured to interact with user device 110, advertising server 130, and/or payment provider server 150 over network 170 to facilitate the sale of products, goods, and/or services. In one example, service provider server 160a and service provider server 160b may be provided by EBAY®, Inc. of San Jose, Calif., USA. Service provider server 160a and service provider server 160b may offer user account services. Service provider server may also correspond to a marketer/advertiser. Thus, service provider server 160a and service provider server 160b may correspond generally to any service provider offering promotion services utilized by user 102.

Service provider server 160a and service provider server 160b include a service application 162a/162b and a network interface component 164a/164b. Service application 162a/162b may correspond to processes, procedures, and/or applications executable by a hardware processor, for example, a software program. In other embodiments, service provider server 120 may include additional or different software as required.

In certain embodiments, service applications 162a/162b may correspond to a marketplace application on a marketplace server enabling a user to view and purchase various products available, for example EBAY®, Inc. of San Jose, Calif., USA. Thus, service applications 162a/162b may include a marketplace interface displayable on user device 110. Service application 162a/162b may facilitate the exchange of money for products using user device 110 and/or payment provider server 150. More generally, service application 162a/162b may provide a service to user 102 over network 170. In this regard, service application 162a/162b may include user account services. However, in other embodiments, service application 162a/162b may include a seller/merchant interface for purchasing products using another user account, such as one offered by payment provider server 150. Transaction information for purchased product by a user, such as user 102, may be transmitted to advertising server 130 with a PID for the purchased product.

Service application 162a/162b may be utilized to transmit promotions and/or seller information to advertising server 130. Thus, service application 162a/162b may receive, generate, and/or transmit promotions to advertising server 130 corresponding to a PID. Service application 162a/162b may correspond to an application utilized by a seller/merchant that may generate promotions for products. However, in other embodiments, service application 162a/162b may correspond to an application utilized by a marketer/advertiser to transmit promotions for a separate seller/merchant. Thus, service application 162a/162b may correspond more generally to a service application offering promotion and advertising services to one or more sellers.

In various embodiments, service provider server 160a and service provider server 160b includes at least one network interface component 164a/164b adapted to communicate with network 170 including user device 110, advertising server 130, and/or payment provider server 150. In various embodiments, network interface component 164a/164b may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

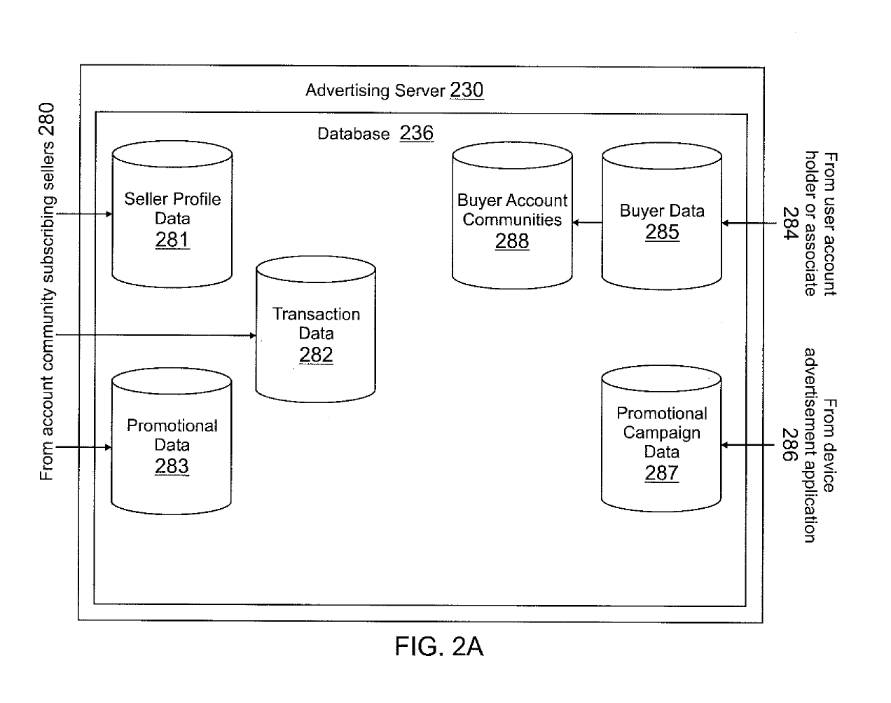

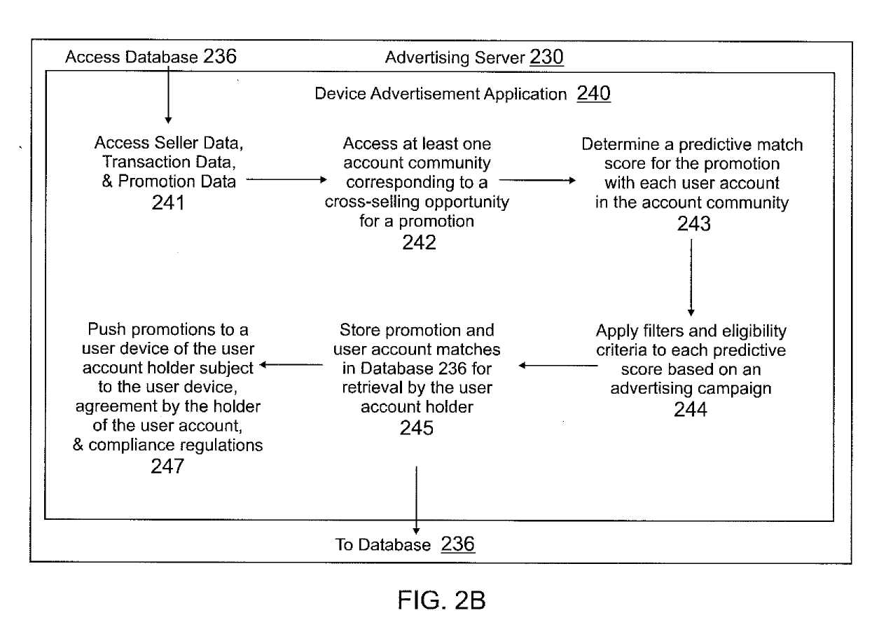

FIG. 2A is an exemplary database for an advertising server having data used to promote to user accounts in an account community, according to an embodiment. FIG. 2A includes an advertising server 230 and a database 236 corresponding generally to advertising server 130 and database 136, respectively, of FIG. 1.

As shown in FIG. 2A, advertising server 230 includes a database 236 having seller profile data 281, transaction data 282, promotional data 283, buyer data 285, promotional campaign data 287, and buyer account communities 288. Each data collection in database 236 may correspond to information utilized for advertising promotions to one or more user accounts in an account community Thus, seller profile data 281, transaction data 282, promotional data 283, buyer data 285, promotional campaign data 287, and buyer account communities 288 may be utilized to determine a match score, filter the match score, and alter future promotions and advertising strategies.

Information from account community subscribing sellers 280 is received by advertising server 230 and stored to database 236 as seller profile data 281, transaction data 282, and promotion data 283. Seller profile data 281 may include a seller category, a seller URL, a seller availability, a seller location, and/or a seller liability coverage and delivery for the product. Transaction data 282 may include a seller identification, a buyer identification, a transaction identification, a buyer account community identification, and/or a timestamp of the transaction. Moreover, transaction information in transaction data 282 may be specific to a Product Identification Number (PID). Promotion data 283 may include a promotion identification, a promotion detail, the PID, a seller identification, promotional status, eligibility criteria (e.g., filters), and/or a timestamp of the promotion.

Information from a user account holder or associate 284 is received by advertising server 230 and stored to database 236 as buyer data 285. An associate of a user account holder may be a server corresponding to the user account, a service subscribed to by the user account holder, etc. Buyer data 285 may include an account profile of the user account, a purchase history of the user account, a response to a similar promotion by the user account, a financial account of the user account, a location corresponding to the user account, preferences of the user account, a user device utilized by the user account holder to log in/access/utilize the user account (e.g., a user device identifier), performance characteristics of the user device, and usage characteristics of the user device.

Information from a device advertisement application (e.g., device advertisement application 140 of FIG. 1) 286 is stored to promotional campaign data 287. The device advertisement application may receive promotions, promotion information, seller information, transaction information, and/or buyer information and process the information to generate promotional campaign data 287. Promotional campaign data 287 may include match scores generated for user accounts in account communities (including identifications for the match scores), promotion identifications, buyer identifications, seller identification, advertisement strategy (e.g., a push or pull advertisement strategy), buyer responses to promotions, and a timestamp corresponding to viewing/reception/etc. of the promotion.

Advertising server 230 may further utilize a community application (e.g., community application 132 of FIG. 1) to generate, maintain, and utilize account communities for use in advertising promotions. Thus, the community application may process buyer data 285 in database 236 to generate buyer account communities 288. Buyer account communities 288 may include account communities of one or more user accounts linked based on an account characteristic. As previously discussed, the user accounts in an account community may correspond to one or plurality of user's accounts linked by shared user specific and/or device specific information.

FIG. 2B is an exemplary server executing a device advertisement application to promote to user accounts in an account community, according to an embodiment. FIG. 2B includes an advertising server 230 and a device advertisement application 240 corresponding generally to advertising server 130 and device advertisement application 140, respectively, of FIG. 1.

Advertising server 230 executes device advertisement application 240 in order to advertise promotions to at least one user account in an account community. Thus, device advertisement application 240 accesses database 236 from FIG. 2A. As previously discussed, information in database 236 may be utilized to advertise the promotions. Device advertisement application 240 may access seller data, transaction data, and promotion data in database 236 at step 241. Device advertisement application 240 may process the information from database 236 and at step 242 access at least one account community corresponding to a cross-selling opportunity for a promotion. As previously discussed, the account communities may be established from buyer data in database 236 by a community application, such as community application 132 of FIG. 1. Device advertisement application 240 may access the account community based on a purchase of a product from a seller by another account in the account community (i.e., cross-selling within a community) or based on a purchase of a product from a seller in common with an account in another account community (i.e., cross-selling across communities).

Once seller data, transaction data, and promotion data are accessed and an account community is accessed, device advertisement application 240 may determine a predictive match score for the promotion with each user account in the account community. The match score may depend on a score for the account community that determines a likelihood accounts in the account community will accept the promotion. Thus, characteristics that determine the account community (e.g., account locations, types of accounts, etc.) may be compared to and judged against the seller data, the transaction data, and the promotion data. Additionally, a score for each user account in the account community may be determined that corresponds to a likelihood the individual user account will accept the promotion. Thus, information about the user account (e.g., holder of the user account, location/type of the specific user account, usage of the user account, available funds/credit by the user account) may be compared to the seller data, the transaction data, and the promotion data. Once each individual score is determined, the individual scores may be used to determine the predictive match score. Each individual score may make up half or a weighted part of the predictive match score. The percentage weight each individual score makes up of the match score may be determined by advertising server 230, by a seller/merchant/advertiser, or by another party, including the holder of the user account.

After a predictive match score is determined, filters and other eligibility criteria are applied to each predictive match score based on an advertising campaign, at step 244. Thus, the advertising campaign may determine only user accounts corresponding to certain age groups, locations, gender, etc. may receive a certain promotion. The demographics may be established by the seller/merchant/advertiser, by advertising server 230 and/or an administrator of advertising server 230, or by the holder of the user account. Only user accounts meeting the filters may then be marked as eligible to receive the promotion. At step 245, promotions and user account matches are stored to database 236 for retrieval by the user account holder. In such an advertising campaign, the user account holder must access advertising server 230 (e.g., through a device application including a dedicated application, messaging application, and/or browser application). However, subject to a user device of the user account holder, agreement by the user account holder (or holder of the user device), and/or compliance regulations, promotions may be pushed to the user device of the user account holder, at step 246.

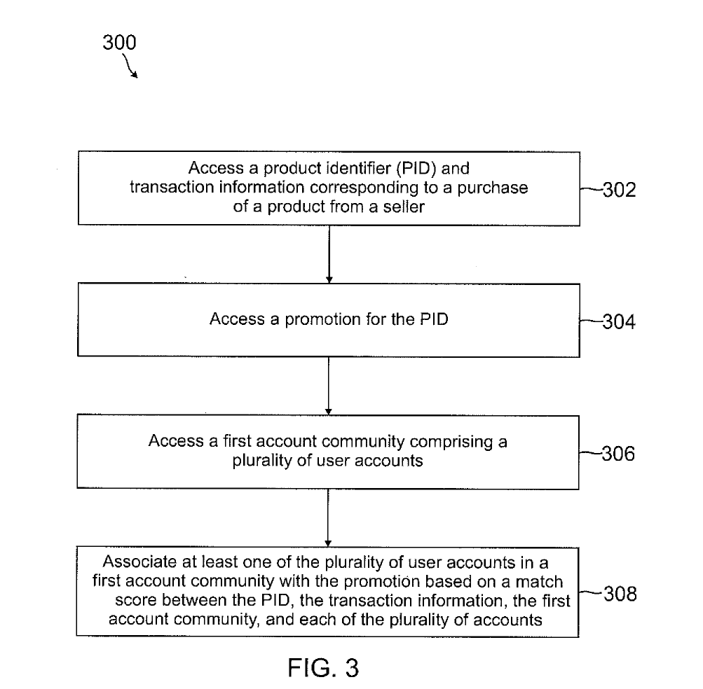

FIG. 3 is a flowchart of an exemplary process by a server for mobile device promotions based on user account community activity, according to an embodiment. Note that one or more steps, processes, and methods described herein may be omitted, performed in a different sequence, or combined as desired or appropriate.

At step 302, a product identifier (PID) and transaction information corresponding to a purchase of a product from a seller is accessed. The PID may correspond to a product, such as identifying the product and/or transaction for use in advertising campaigns. Transaction information may correspond to seller identification, buyer identification, transaction identification, buyer account community identification, and/or a timestamp of the transaction.

A promotion for the PID is accessed, at step 304. A promotion may be generated and transmitted to an advertising/payment provider/etc. server by a seller, a merchant, and/or an advertiser/marketer (e.g., an advertising agency). In other embodiments, the server may generate the promotion itself. A promotion may include promotion identification, a promotion detail, the PID, seller identification, promotional status, eligibility criteria, and a timestamp of the promotion.

At step 306, a first account community comprising a plurality of user accounts is accessed. The first account community may include user accounts linked based on shared account characteristics, for example, account location, IP address, financial information, personal information of an account holder, etc. The purchase of the product in step 302 may include the purchase of the product by a first user account of the first account community. In other embodiments, the purchase of the product may correspond to the purchase of the product by a second user account of a second account community, where the second user account and a third user account of the first account community purchased from a common seller.

At step 308, at least one of the plurality of user accounts in a first account community is associated with the promotion based on a match score between the PID, the transaction information, the first account community, and each of the plurality of accounts. The match score may comprise a determination of a likelihood that the at least one of the plurality of accounts accepts the promotion. Additionally, the determination of the likelihood may be based on at least one of an account profile of the at least of the plurality of user accounts, a purchase history of the at least of the plurality of user accounts, a response to a similar promotion by the at least of the plurality of user accounts, a financial account of the at least of the plurality of user accounts, a location corresponding to the at least of the plurality of user accounts, preferences of the at least of the plurality of user accounts, a user device of the at least of the plurality of user accounts, performance characteristics of the user device, and/or usage characteristics of the user device. As previously discussed, the match score may comprise two elements that are weighted to a final match score, the likelihood the account community accepts/matches the promotion and the likelihood an individual account in the account community accepts the promotion. Thus, the match score may comprise a first predictive score that the promotion and the first account community match based on promotion information and first account community information and a second predictive score that the promotion and the at least one of the plurality of user accounts match based on the promotion information and the at least one of the plurality of user accounts. The scores may be normalized and aligned so two scores of the same value indicate an equal likeliness of accepting the promotion.

Additionally, seller information may be received comprising at least one of a seller category, a seller URL, a seller availability, a seller location, and a seller liability coverage and delivery for the item. The match score and thus the association of the at least one of the plurality of user accounts to the promotion may depend on the seller information.

Two advertising strategies may be utilized to advertise the promotion. In a pull strategy, a request to access community advertisement may be received from the at least one of the plurality of user accounts and the promotion transmitted to a user device of the at least one of the plurality of user accounts based on the user device. In a push strategy, the promotion may be transmitted to the user device of the at least of the plurality of user accounts based on the user device, agreement of the at least of the plurality of user accounts, and compliance regulations corresponding to the user device.

After the user device either accesses the community advertisements or receives the promotion, a user utilizing the user device may have a response to the promotion. For example, the user may read the promotion, may access a merchant website to learn more about an item in the promotion, may utilize the user device to make a purchase corresponding to the promotion, or may ignore/delete the promotion. Thus, a user response to the promotion may be analyzed and used to determine a promotion success rating based on the user response. The promotion success rating may be used for future advertisement campaigns.

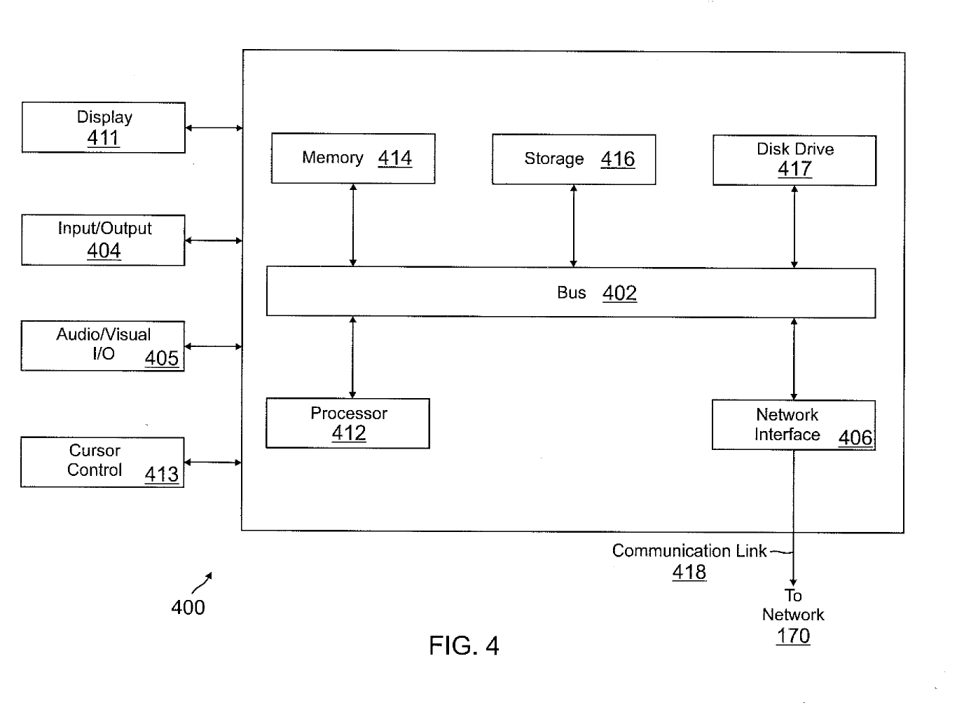

FIG. 4 is a block diagram of a computer system 400 suitable for implementing one or more embodiments of the present disclosure. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a service provider server via network 170. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user account information comprising a first account community; and
one or more hardware processors in communication with the non-transitory memory and configured to:
access a product identifier (PID) and transaction information corresponding to a purchase of an product from a seller;
access a promotion for the PID;
access the first account community comprising a plurality of user accounts; and
associate at least one of the plurality of user accounts in the first account community with the promotion based on a match score between the PID, the transaction information, the first account community, and each of the plurality of accounts.

2. The system of claim 1, wherein the transaction information comprises at least one of a seller identification, a buyer identification, a transaction identification, a buyer account community identification, and a timestamp of the transaction.

3. The system of claim 1, wherein the promotion comprises at least one of a promotion identification, a promotion detail, the PID, a seller identification, promotional status, eligibility criteria, and a timestamp of the promotion.

4. The system of claim 1, wherein the one or more hardware processors is further configured to:
receive seller information comprising at least one of a seller category, a seller URL, a seller availability, a seller location, and a seller liability coverage and delivery for the product,
wherein the at least one of the plurality of user accounts is further associated with the promotion using the seller information.

5. The system of claim 1, wherein the purchase of the product comprises the purchase of the product by a first user account of the first account community.

6. The system of claim 1, wherein the purchase of the product comprises the purchase of the product by a second user account of a second account community, and wherein the second user account and a third user account of the first account community purchased from a common seller.

7. The system of claim 1, wherein the match score comprises a determination of a likelihood that the at least one of the plurality of accounts accepts the promotion.

8. The system of claim 7, wherein the determination of the likelihood is based on at least one of an account profile of the at least of the plurality of user accounts, a purchase history of the at least of the plurality of user accounts, a response to a similar promotion by the at least of the plurality of user accounts, a financial account of the at least of the plurality of user accounts, a location corresponding to the at least of the plurality of user accounts, preferences of the at least of the plurality of user accounts, a user device of the at least of the plurality of user accounts, performance characteristics of the user device, and usage characteristics of the user device.

9. The system of claim 1, wherein the one or more hardware processors is further configured to:
generate the match score comprising:
a first predictive score that the promotion and the first account community match based on promotion information and first account community information; and
a second predictive score that the promotion and the at least one of the plurality of user accounts match based on the promotion information and the at least one of the plurality of user accounts.

10. The system of claim 1, wherein the one or more hardware processors is further configured to:
receive a request to access community advertisements from the at least one of the plurality of user accounts;
transmit the promotion to a user device of the at least one of the plurality of user accounts based on the user device.

11. The system of claim 1, wherein the one or more hardware processors is further configured to:
transmit the promotion to a user device of the at least of the plurality of user accounts based on the user device, agreement of the at least of the plurality of user accounts, and compliance regulations corresponding to the user device.

12. The system of claim 1, wherein the one or more hardware processors is further configured to:
analyze a user response to the promotion;
determine a promotion success rating based on the user response, wherein the promotion success rating is used for future advertisement campaigns.

13. A method comprising:
accessing a product identifier (PID) and transaction information corresponding to a purchase of an product from a seller;
accessing a promotion for the PID;
accessing a first account community comprising a plurality of user accounts; and
associating, using one or more hardware processors, at least one of the plurality of user accounts in the first account community with the promotion based on a match score between the PID, the transaction information, the first account community, and each of the plurality of accounts.

14. The method of claim 13 further comprising:
receiving seller information comprising at least one of a seller category, a seller URL, a seller availability, a seller location, and a seller liability coverage and delivery for the product.
wherein the at least one of the plurality of user accounts is further associated with the promotion using the seller information.

15. The method of claim 13, wherein the purchase of the product comprises one of the purchase of the product by a first user account of the first account community and the purchase of the product by a second user account of a second account community, and wherein the second user account and a third user account of the first account community purchased from a common seller.

16. The method of claim 13 further comprising:
generating the match score comprising:
a first predictive score that the promotion and the first account community match based on promotion information and first account community information; and
a second predictive score that the promotion and the at least one of the plurality of user accounts match based on the promotion information and the at least one of the plurality of user accounts.

17. The method of claim 13 further comprising:
receiving a request to access community advertisements from the at least one of the plurality of user accounts;
transmitting the promotion to a user device of the at least one of the plurality of user accounts based on the user device.

18. The method of claim 13 further comprising:
transmitting the promotion to the user device of the at least of the plurality of user accounts based on the user device, agreement of the at least of the plurality of user accounts, and compliance regulations corresponding to the user device.

19. The method of claim 13 further comprising:
analyzing a user response to the promotion;
determining a promotion success rating based on the user response, wherein the promotion success rating is used for future advertisement campaigns.

20. A non-transitory computer readable medium comprising a plurality of machine-readable instructions which when executed by one or more processors of a server are adapted to cause the server to perform a method comprising:
accessing a product identifier (PID) and transaction information corresponding to a purchase of an product from a seller;
accessing a promotion for the PID;
accessing a first account community comprising a plurality of user accounts; and
associating at least one of the plurality of user accounts in the first account community with the promotion based on a match score between the PID, the transaction information, the first account community, and each of the plurality of accounts.
